(19) United States
(12) Patent Application Publication
(10) Pub. No.: US 2005/0003304 A1
(43) Pub. Date: Jan. 6, 2005

(54) Computer-to-plate by ink jet

(75) Inventors: Marc Van Damme, Bonheiden (BE); Rudi Mayers, Moortown Leeds (GB); Peter Hendrikx, Hamont-Achel (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: AGFA-GEVAERT, Mortsel (BE)

(21) Appl. No.: 10/843,078

(22) Filed: May 11, 2004

Related U.S. Application Data
(60) Provisional application No. 60/477,243, filed on Jun. 10, 2003.

(30) Foreign Application Priority Data
May 14, 2003 (EP) 03101334.5

(51) Int. Cl. G03C 1/76

(52) U.S. Cl. 430/302

(57) ABSTRACT

A method for preparing a lithographic printing plate by means of ink jet printing is disclosed. The invention involves a method for controlling the resolution of an image formed by ink yet printing with an ink comprising at least one transition metal complex on a specific surface treated substrate.

### CROSS-REFERENCE TO RELATED PATENT APPLICATIONS

This application claims the benefit of U.S. Provisional Application No. 60/477,243 filed Jun. 10, 2003, which is incorporated by reference. In addition, this application claims the benefit of European Application No. 03101334.5 filed May 14, 2003, which is also incorporated by reference.

### FIELD OF THE INVENTION

The present invention relates to a method for preparing a lithographic printing plate by means of ink jet printing.

### BACKGROUND OF THE INVENTION

Traditional techniques of printing include letterpress printing, gravure printing and offset lithography. All of these printing methods require a plate, usually loaded onto a plate cylinder of a rotary press for efficiency, to transfer ink in the pattern of the image. In letterpress printing, the image pattern is represented on the plate in the form of raised areas that accept ink and transfer it onto the recording medium by impression. Gravure printing cylinders, in contrast, contain series of wells or indentations that accept ink for deposit onto the recording medium.

In the case of traditional offset lithography the image to be printed is present on a plate as a pattern of ink accepting (oleophilic) areas on an ink repellent (oleophobic or hydrophilic) background. In the wet system the required ink repellency is provided by an initial application of a dampening (or fountain) solution prior to inking. Conventional presensitized lithographic printing plates are provided with a UV sensitive coating based on photopolymer or diazonium chemistry. The plates have to be UV-exposed through a mask carrying the image. The mask is a graphic arts film prepared by photographic techniques based on silver halide chemistry and involving exposure by a camera or by an image-setter, and further involving wet processing.

Printing plate precursors are called ‘negative-working’ when upon image-wise exposure the exposed areas become insoluble in an aqueous alkaline developer and define the image areas (printing areas) of the printing master. The unexposed areas on the other hand, remain soluble in an aqueous alkaline developer. In positive-working materials the exposed areas dissolve in the developer and define the non-printing areas. A disadvantage of these traditional methods is the necessary cumbersome preparation of the photographic intermediate film involving wet processing. A further drawback is the wet processing of the printing plate itself.

With the advent of the computer in revolutionizing the graphics design process leading to printing, there have been extensive efforts to develop a convenient and inexpensive computer-to-plate system wherein a photographic intermediate is no longer required. In recent years some of these systems are introduced into the market based on different chemical systems and exposure methods. For instance, the SETPRINT material, trade mark of Agfa-Gevaert N.V. is based on silver halide DTR chemistry and consists of a polyethylene terephthalate base carrying a photographic coating which after photo-mode exposure and processing produces complementary oleophilic and hydrophilic areas. Another system based on photo-mode exposure but with a hydrophilic aluminum base is LITHOSTAR, trade mark of Agfa-Gevaert N.V. A system based on heat mode exposure by means of an intense infrared laser is called THERMOSTAR, also a trade mark of Agfa-Gevaert N.V.

Many of the new computer-to-plate systems are large, complex, and expensive. They are designed for use by large printing companies as a means to streamline the pre-press process of their printing operations and to take advantage of the rapid exchange and response to the digital information of graphics designs provided by their customers. There remains a strong need for an economical and efficient computer-to-plate system for the many smaller printers who utilize lithographic printing.

A number of electronic, non-impact printing systems have been investigated for use in making lithographic printing plates to satisfy the needs of these smaller printers. Foremost among these have been laser printing systems, for example as described in U.S. Pat. No. 5,304,443 and references therein. Another non-impact printing system which has received attention for economical and convenient computer-to-plate preparation for lithographic printing is thermal transfer printing, for example, as described in U.S. Pat. No. 4,958,564.

In recent years, ink jet printers have replaced laser printers as the most popular hard copy output printers for personal computers. Some of the competitive advantages of ink jet printers are low cost and reliability. The ink jet printing system is a relatively rapid image output system and has a simple construction because it does not require any complex optical system. In recent times, there have been some reports in the literature proposing the use of ink jet printers to make lithographic printing plates.

In Japanese Kokai 62-25081, an oleophilic liquid or fluid ink is printed by ink jet printing onto a hydrophilic aluminum surface of a lithographic printing plate. Titanate or silane coupling agents are present in the ink.

An ink jet printing apparatus to make lithographic printing plates is described in WO 94/11191. It is directed to depositing hydrophobic or hydrophilic substances on hydrophobic printing plates.

In U.S. Pat. No. 5,501,150, a fluid ink and hydrophilic media set containing materials to produce a silver-reducible image by ink jet printing are used to make a metallic silver image which, following wet processing to make the silver image sufficiently hydrophobic, is said to provide a lithographic printing plate.

Ink jet printing wherein the ink is a solid or phase change type ink instead of a liquid or fluid type ink is described in U.S. Pat. No. 4,833,486 to deposit a hot wax on a surface of an offset plate. Upon cooling of the wax, it solidifies, thereby providing a printing plate. Solid ink jet printing has serious disadvantages for lithographic plates in that the wax or resin image has limited durability due to its thermoplastic, chemical, and adhesive properties and the amount and rounded shape of the solidified ink jet droplet on the media do not have the intrinsic image resolution properties found in liquid ink jet printing.

There is also prior art in the use of ink jet printing to apply an opaque image or mask pattern to a photosensitive lithographic printing plate blank, as for example, in Japanese Kokai 63-109,052. The blank is then exposed through the ink jet imaged mask pattern and then processed by conventional means to provide a lithographic printing plate. This approach retains the materials and processing of conventional lithographic printing plates and uses ink jet printing as an alternative for the photomask through which the conventional plates are exposed. U.S. Pat. No. 5,495,803 describes a solid or phase change type of ink jet printing to form a photomask for a printing plate.

As a further example of the methods for preparing printing plates by using the ink jet printing system, Japanese Kokai Publication 113456/1981 proposes methods for preparing printing plates whereby ink-repelling materials (e.g. curable silicones) are printed on a printing plate by ink jet printing. The printing plate obtained by this method is an intaglio printing plate in which the ink-repelling material formed on the surface of the substrate serves as a non-image part.

U.S. Pat. No. 5,511,477 discloses a method for the production of photopolymeric relief-type printing plates comprising the formation of a positive or a negative image on a substrate by ink jet printing with a photopolymeric ink composition, optionally preheated to a temperature of about 30°-260° C., and subjecting the resulting printed substrate to UV radiation, thereby curing the ink composition forming the image.

U.S. Pat. No. 5,312,654 discloses a method for making lithographic printing plates comprising the formation of an image on a substrate having an ink absorbing layer and a hydrophilized layer between the substrate and the absorbing layer by ink jet printing using a photopolymerizable ink composition, and exposing it to an actinic light in the wavelength region with which said ink composition is sensitized to cure the image.

Japanese Kokai Publication 69244/1992 discloses a method for making printing plates comprising the steps of forming a printed image on a recording material subjected to a hydrophilic treatment by ink jet printing using a hydrophobic ink containing photocurable components, and exposing the whole surface to actinic light.

EP 533,168 discloses a method for avoiding ink spreading by coating the lithographic base with an ink absorbing layer which is removed after ink printing.

Research Disclosure 289118 of May 1988 discloses a method for making printing plates with the use of an ink jet wherein the ink is a hydrophobic polymer latex.

JN 57/038142 discloses a method of preparing a printing plate by forming an ink image on a blank printing plate, and also by fixing this image thermally by making toner to adhere to this image is formed area.

JN 07/108,667 discloses a plate-making method forming an ink image containing a hydrophilic substance on a conductive support whose surface layer is made hydrophilic according to an electrostatic attraction type ink set system to dry or cure the same, by applying bias voltage to the conductive support at the time of ink jet writing.

U.S. Pat. No. 5,213,041 discloses a method for preparing a reusable printing plate for printing, projecting an imaging deposit on the plate surface by ink jet printing using an ejectable substance containing a heat fusible component. The image forms an imaging deposit which is fused to the surface of the printing plate using a variable frequency and variable power induction heater.

In U.S. Pat. No. 6,455,132 a fluid composition is described comprising a copolymer, having a plurality of tertiary amine sites selected from the group consisting of polyacrylates, polyamides, styrenated polyacrylates and polyurethanes, which can be applied by an ink jet printing apparatus.

In WO 0154903 a fluid composition is described which has a variable viscosity at different temperatures thereby controlling the spreading of the fluid on the substrate. In a preferred embodiment the fluid composition comprises at least one noncycloaliphatic epoxy composition, at least one cycloaliphatic epoxy compound and at least one UV radiation initiator compound.

In WO 0154915 a method for controlling the resolution of an image formed on a substrate by ink jet printing is described wherein a fluid composition comprises a surfactant whereas in WO 0076779, a surfactant is applied on the substrate for controlling the resolution of an image.

In EP-A 1157825 a method is disclosed for the preparation of a lithographic printing plate, comprising dispensing information-wise by means of ink jet printing droplets of a fluid onto a surface of a lithographic receiver, characterized in that said fluid contains an oleophilizing agent having in its chemical structure a phosphorous containing group capable of reacting with said surface of said lithographic receiver.

In U.S. Pat. No. 5,738,013, U.S. Pat. No. 5,849,066 and US 2001/0007464 a lithographic printing plate is manufactured by means of an ink jet fluid comprising reactive components selected from the group consisting of transition metal complexes. In a preferred embodiment the reactive compound comprises one or more chromium complexes of organic acids.

### SUMMARY OF THE INVENTION

A problem which is not solved by the latter prior art documents is the spreading of these ink jet fluids on a substrate resulting in poor images after ink jet printing. It is an object of the present invention to provide a method of lithographic plate making by ink-jet printing which is characterized by reduced ink spreading, thereby enabling the production of plates carrying a high resolution image. This object is realized by the method in claim 1 and by the specific embodiments in the dependent claims.

After ink jet printing with a fluid comprising at least one transition metal complex reactive component on a hydrophilic metal which is anodized in phosphoric acid or in a mixture of sulphuric acid and phosphoric acid, the obtained lithographic printing plate is preferably exposed to an external energy source or other suitable means to cause the reaction of the reactive component. This forms an effective amount of a durable and water-insoluble pattern on the lithographic plate, thereby preparing it for high quality lithographic printing at a high run length.

### DETAILED DESCRIPTION OF THE INVENTION

The different components used in accordance with the method of the present invention will now be explained in detail.

I. The Ink Jet Fluid

The ink jet fluid used in the present invention comprises a transition metal complex reactive component. In a preferred embodiment, the ink jet fluid comprises one or more chromium complexes of organic acids such as the complexes sold under the QUILON trade name by DuPont Corporation. Preferably said organic acids of the chromium complexes comprise oleophilic groups, such as myristic acid and stearic acid. In yet another embodiment, one or more of the chromium complexes comprise a complex of trivalent chromium and an organic carboxylic acid. An example of such a chromium complex is QUILON C, a 25 to 30% by weight solution of a complex of trivalent chromium and myristic acid (chromium, di-pentahydroxy(tetradecanoate) CAS Nr. 65229-24-5) in isopropyl alcohol; further examples are described in Quilon Chrome Complexes, Dupont Corporation, April 1992. In another preferred embodiment, the ink jet fluid comprises one or more chromium complexes of organic acids, wherein one or more of the organic acids of the chromium complexes comprise radiation-sensitive reactive groups, such as unsaturated acrylic or vinyl groups. Examples of these reactive components of chromium complexes of organic acids having a radiation-sensitive reactive group are the chromium complexes of unsaturated organic acids sold under the VOLAN trade name by DuPont Corporation, Wilmington, Del. More detailed information on the transition metal complexes can be found in U.S. Pat. No. 5,738,013, U.S. Pat. No. 5,849,066, U.S. Pat. No. 5,971,535, US 2001/0007464.

A typical ink jet fluid used in ink jet printing may further comprise reactive components such as an isocyanate, blocked isocyanate, diketene, diketene emulsion, polyamide epoxide, acid anhydride or acid chloride. Examples of these reactive components include isocyanates sold under the LUPRANATE trade name by BASF Corporation, such as LUPRANATE M205; blocked isocyanates sold under the DESMODUR trade name by Bayer Corporation, such as DESMODUR BL3175; diketenes sold under the AQUAPEL trade name by Hercules Corporation; diketene emulsions sold under the HERCON trade name by Hercules Corporation, such as HERCON 79; polyamide epoxides sold under the POLYCUP trade name by Hercules Corporation, such as POLYCUP 172; acid anhydrides sold under the GANTREZ trade name by ISP Corporation, such as long alkyl chain vinyl ether-maleic anhydride copolymers and palmitoyl chloride from Aldrich Chemical Company.

The reactive components are preferably capable of forming an oleophilic, water insoluble, and durable image when printed on a hydrophilic layer and subsequently being exposed to an external energy source or other suitable means to cause the reaction of the reactive component. For non-radiation reactive components the preferred external energy source is heat. The heat can be applied via hot air or also via near-infrared or infrared radiation. For radiation curable components radiation such as electron beam radiation, ultraviolet radiation, visible radiation and infrared radiation are preferred as external energy source. In addition, the reactive components are preferably compatible and stable enough to be utilized in at least one type of ink jet printhead with a suitable liquid carrier.

In a preferred embodiment, a catalyst is added to the ink jet fluid to increase the rate of reaction of the reactive component after printing and upon exposure to the external energy source or other suitable means to cause reaction. In a most preferred embodiment, the added catalyst is a metal complex, such as stannous stearate. In one embodiment, the added catalyst is a sensitizer to accelerate the reaction of the radiation sensitive groups. For example, as is known in the art of reacting materials with radiation sensitive groups such as unsaturated acrylic groups, a photosensitizer may be added to accelerate the reaction from exposure to ultraviolet or visible light or a peroxide compound may be added to accelerate the reaction by heating.

The ink jet fluid preferably further comprises water or organic solvents or combinations thereof as liquid carrier. The choice of the specific liquid carrier depends on the specific ink jet printer and its compatible ink jet printing head and cartridge being used for the ink jet printing. It also depends on the specific reactive component selected. The compatibility with both the ink jet hardware and with the reactive component is important in the selection of the liquid carrier. The types of liquid carriers suitable for use with the different types of ink jet printheads is known in the art, for example, as described in U.S. Pat. No. 5,085,698. Reactive components such as isocyanates, ketenes, and acid anhydrides for example, are typically sufficiently reactive with water that they would only be compatible with non-aqueous or organic liquid carriers. In general, the piezoelectric and continuous flow types of ink jet printheads have a wider latitude of acceptable liquid carriers than the thermal or bubble type of ink jet printheads. For example, piezoelectric ink jet printheads work acceptably with various non-aqueous or organic liquid carriers while thermal ink jet printheads typically need a high percentage of water or volatile organic solvent in the liquid carrier. While water is the preferred medium for aqueous inks, the aqueous composition may comprise one or more water miscible solvents e.g. a polyhydric alcohol such as ethylene glycol, diethylene glycol, triethylene glycol or trimethylol propane. Such polyhydric alcohols function as so-called humectants preventing the ink from drying out in the orifices of the print head. The amount of aqueous carrier medium in the aqueous composition may be in the range from 30 to 99.995, preferably from 50 to 95% by weight. Also organic solvents may be used as a carrier medium for the ink e.g. alcohols, ketones or acetates.

As known for the ink jet technology, the jet velocity, separation length of the droplets, drop size and stream stability is greatly affected by the surface tension and the viscosity of the aqueous composition. Ink jet inks suitable for use with ink jet printing systems may have a surface tension in the range from 20 to 60, preferably from 30 to 50 dynes/cm. Control of surface tensions in aqueous inks may be accomplished by additions of small amounts of surfactants. The amount of surfactants to be used can be determined through simple trial and error experiments. Several anionic and nonionic surfactants are known in the ink-jet art. Commercial surfactants include the SYRFINOL™ series, trade name from Air Products; the ZONYL™ series, trade name from DuPont; the FLUORAD™ series, trade name from 3M, and the AEROSOL™ series, trade name from Cyanamid.

The ink may further comprise other ingredients. A biocide may be added to prevent unwanted microbial growth, which may occur in the ink over time. Additional additives that may be optionally present in the ink include thickeners, pH adjusters, buffers, conductivity enhancing agents, drying agents, and defoamers.

In order to enhance the image contrast after jetting the image on a lithographic receiver, dyes can be added. Many dyes and pigments are known to be suited for the ink jet technology. Suitable dyes are further selected based on their compatibility with the carrier medium (i.e. aqueous based or solvent based) and on their compatibility with the oleophilizing agent i.e. they should not lead to coagulation. Especially favored for aqueous inks are cationic dyes such as crystal violet.

II. The Image Receiving Substrate

The support for the lithographic printing plate of the present invention comprises a support having a hydrophilic metallic surface which is preferably aluminum. According to a preferred embodiment of this invention, the support is formed of aluminum which has been grained by electrochemical graining, and anodized by means of anodizing techniques employing phosphoric acid or a sulphuric acid/phosphoric acid mixture. Methods of both graining and anodizing are very well known in the art.

By graining (or roughening) the aluminum substrate, both the adhesion of the printing image and the wetting characteristics of the non-image areas are improved. By varying the type and/or concentration of the electrolyte and the applied voltage in the graining step, different type of grains can be obtained. The roughness of a surface can be measured via different techniques; for example by traversing a stylus across the surface giving an average reading on a meter expressed as arithmetical mean centre-line Roughness (Ra) values or sometimes also referred to as CLA (Centre Line Average). Ra as used herein is defined in ISO 4287/1 (=DIN 4762) and references therein. Ra values reported herein have been measured according to ISO 4288 and references therein by a mechanical profile method using a contact stylus with a very thin tip (also optical profile methods are known; such optical methods systematically provide higher values than the ISO method). The apparatus used for measuring Ra was a Talysurf 10 from Taylor Hobson Ltd.

By using a mixture of hydrochloride and phosphoric acid during graining, lower Ra values are obtained (over a limited range) while by using hydrochloride in combination with certain carboxylic acids, low Ra values as well as wide ranges of roughnesses can be obtained. Typically the Ra values vary between 0.2-1.5 μm, the lower limit of the Ra value may be 0.05 μm, preferably 0.1 μm. More details of electrolytic graining of aluminum surfaces are described in GB 1598701.

By anodizing the aluminum support, its abrasion resistance and hydrophilic nature is improved. The microstructure as-well as the thickness of the Al₂O₃ layer are determined by the anodizing step, the anodic weight (g/m² Al₂O₃ formed on the aluminum surface) varies between 1 and 8 g/m². According to our invention, the anodization is carried out in phosphoric acid or in a mixture of phosphoric acid and sulphuric acid and the diameter of the pores of the anodic layer obtained via this anodization technique is larger compared to anodization carried out in sulphuric acid alone. The type of anodization, i.e. in sulphuric acid, phosphoric acid or in a mixture of both, can be identified using the re-anodization procedure as described in the article “Assessment of lithographic printing plate processing using a re-anodizing procedure” published by R. Mayers, V. Chau, G. E. Thompson, in Proceedings of 2nd International Symposium on Aluminum Surface Science and Technology, UMIST, Manchester, England, UK (2000) 327-334. An example of an anodizing treatment is carried out for 0.25 to 4 minutes using as electrolyte an aqueous solution containing 20-150 g/l (preferably 40 to 100 g/l) sulphuric acid and 250-380 g/l phosphoric acid at a voltage of 15-35 V and a temperature of 15-46° C. More details of anodizing techniques of aluminum supports are described in GB 2088091.

The grained and anodized aluminum support may be post-treated to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with an organic acid and/or salt thereof, e.g. carboxylic acids, hydrocarboxylic acids, sulphonic acids or phosphonic acids, or their salts, e.g. succinates, phosphates, phosphonates, sulphates, and sulphonates. A citric acid or citrate solution is preferred. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulphonic acid, polyvinylbenzenesulphonic acid, sulphuric acid esters of polyvinyl alcohol, and acetals of polyvinyl alcohols formed by reaction with a sulphonated aliphatic aldehyde. It is further evident-that one or more of these post-treatments may be carried out alone or in combination. More detailed descriptions of these treatments are given in GB 1084070, DE 4423140, DE 4417907, EP 659909, EP 537633, DE 4001466, EP 292801, EP 291760 and U.S. Pat. No. 4,458,005.

III. Optional Baking and/or Gumming Steps

After writing the image, and optional exposure to an energy source, the printing plate can be inked with printing ink in the normal way, and the plate can be used on a printing press. Before inking, the plate can be treated with a finishing gum as is known by the experts in the field. The treatment of the printing plate of the present invention with a finishing gum further improves the printing quality of the plate. However, when the printing plate is post-treated with polyvinylphosphonic acid, the quality of the plate is already optimal and the finishing gum step may be omitted. Typically the finishing gum is an aqueous solution of natural gum, such as gum acacia, or of a synthetic gum such as carboxymethyl cellulose, as it is well known in the art of printing. Additionally, the gum can contain surfactants of various types. Examples of commercially available gum solutions include RC 795 or RC 515, trademarks of Agfa.

IV. The Ink Jet Printing Process

In ink jet printing tiny drops of ink fluid are projected directly onto an ink receptor surface without physical contact between the printing device and the receptor. The printing device stores the printing data electronically and controls a mechanism for ejecting the drops image-wise. Printing is accomplished by moving the print head across the paper or vice versa. Early patents on ink jet printers include U.S. Pat. No. 3,739,393, U.S. Pat. No. 3,805,273 and U.S. Pat. No. 3,891,121.

The jetting of the ink droplets can be performed in several different ways. In a first type of process a continuous droplet stream is created by applying a pressure wave pattern. This process is known as continuous ink jet printing. In a first embodiment the droplet stream is divided into droplets that are electrostatically charged, deflected and recollected, and into droplets that remain uncharged, continue their way undeflected, and form the image. Alternatively, the charged deflected stream forms the image and the uncharged undeflected jet is recollected. In this variant of continuous ink jet printing, several jets are deflected to a different degree and thus record the image (multideflection system).

According to a second process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

The present invention will now be illustrated by the following examples without however being limited thereto.

### EXAMPLES

1. Preparation of Anodized Aluminum Substrates.

Preparation of Aluminum Supports Anodized in a Mixture of Sulphuric Acid/Phosphoric Acid.

An overview of the different substrates is given in Table 6 examples 1 to 12.

Degrease Step

A 0.30 mm thick aluminum foil was degreased by immersing the foil in an aqueous solution containing 10 g/l of sodium hydroxide at 40° C. for 45 seconds and rinsed with demineralized water.

Graining

The foil was then electrochemically grained using an alternating current (as indicated in Table 1) in an aqueous solution containing 9 g/l of hydrochloric acid and 22.5 g/l of acetic acid at a temperature of 35° C. for 25 seconds. By varying the current density the surface topography was varied. The CLA (Centre Line Average) was varied from 0.4 to 1.0 μm.

TABLE 1

| CLA | Current density |
|---|---|
| (μm) | (A/m²) |
| 0.4 | 600 |
| 0.7 | 1000 |
| 1.0 | 1400 |

Desmut

After rinsing with demineralized water the aluminum foil was then etched with an aqueous solution containing 135 g/l of phosphoric acid at 40° C. for 25 seconds and rinsed with demineralized water at 25° C. for 30 seconds.

Anodization

The foil was subsequently subjected to anodic oxidation in an aqueous solution containing 50 g/l of sulfuric acid and 340 g/l of phosphoric acid at a temperature of 45° C. for 25 seconds. The current density was varied to obtain different weights of the anodic layer. Details for the current density setting are listed in Table 2.

TABLE 2

| Al₂O₃ | Current density |
|---|---|
| (weight g/m²) | (A/m²) |
| 2 | 430 |
| 3 | 500 |
| 4 | 570 |

Post Anodic Treatment

Next the foil was washed with demineralized water and post-treated with an aqueous solution. Different post anodic treatments were carried out. The details (concentration, dwell time and temperature) are listed in Table 3. After the post anodic treatment the substrate was rinsed with water.

TABLE 3

| | Conc. | T | Dwell time |
|---|---|---|---|
| Ingredient | (g/l) | (° C.) | (s) |
| Water | — | 25 | 60 |
| Polyvinylphosphonic acid | 1.5 | 45 | 60 |
| (CPD) | | | |
| Sodium bicarbonate | 14 | 27.5 | 60 |
| (SBC) | | | |
| Potassium Orthophosphate | 10 | 45 | 60 |
| (OPP) | | | |
| Potassium | 5 | 40 | 60 |
| Hexafluorzirconate (ZAT) | | | |

Preparation of Comparative Aluminum Supports Anodized in Sulphuric Acid.

An overview of the different substrates is given in Table 6 comparative examples 1 to 8.

The degrease step, graining, desmut, and the post anodic treatment were carried out as described in the preparation of the sulphuric acid/phosphoric acid anodized aluminum supports. For the anodization the following procedure was used.

Anodization

The foil was subsequently subjected to anodic oxidation in an aqueous solution containing 105 g/l of sulfuric acid at a temperature of 45° C. for 25 seconds. The current density was varied to obtain different weights of the anodic layer. Details for the current density setting are listed in Table 4.

TABLE 4

| Al₂O₃ | |
|---|---|
| (weight g/m²) | Current density (A/m²) |
| 2 | 250 |
| 3 | 550 |
| 4 | 750 |

2. Preparation of an Ink Jet Fluid.

An ink jet fluid prepared by adding the Quilon C compound (trademark of Dupont) to deionized water and isopropanol. Next crystal violet, a cationic dye commercially available from Aldrich, was added. The mixture was stirred to ensure homogeneous mixing, and filtered through a 1 μm pore size filter. The ink jet fluid composition is given in Table 5.

TABLE 5

| | Parts |
|---|---|
| Ingredient | (g) |
| Crystal Violet | 100 |
| (1% w/w solution in water) | |
| Quilon C | 12 |
| Deionized water | 88 |

3. Preparation of the Lithographic Printing Plate.

The ink jet fluid was loaded into an ink-jet cartridge of an Epson 900 ink-jet printer. A screen with 1% coverage was imaged at 567 dots per cm (1440 dpi) onto the anodized aluminum printing plate which had been loaded into the printer. After drying the diameter of the dot size on the plate was measured under the microscope. The smaller the dot size, the smaller the spreading of the fluid on the aluminum substrate.

4. Results.

The results of the dot size measurements are listed in Table 6.

TABLE 6

| | | Anodic | Roughness | Post | Dot size |
|---|---|---|---|---|---|
| | | weight | CLA | Anodic | (diameter |
| Example | Anodization* | (g/m²) | (μm) | Dip** | μm)*** |
| 1 | SA + PA | 2 | 1 | Water | 42 |
| 2 | SA + PA | 3 | 1 | Water | 36 |
| 3 | SA + PA | 4 | 1 | Water | 32 |
| 4 | SA + PA | 2 | 0.4 | Water | 36 |
| 5 | SA + PA | 2 | 0.7 | Water | 38 |
| 6 | SA + PA | 4 | 0.4 | CPD | 35 |
| 7 | SA + PA | 4 | 0.7 | CPD | 43 |
| 8 | SA + PA | 4 | 1.0 | CPD | 44 |
| 9 | SA + PA | 4 | 0.4 | Water | 35 |
| 10 | SA + PA | 4 | 0.4 | SBC | 32 |
| 11 | SA + PA | 4 | 0.4 | OPP | 35 |
| 12 | SA + PA | 4 | 0.4 | ZAT | 51 |
| Comp. 1 | SA | 2 | 1 | Water | 48 |
| Comp. 2 | SA | 3 | 1 | Water | 45 |
| Comp. 3 | SA | 4 | 1 | Water | 41 |
| Comp. 4 | SA | 2 | 0.4 | Water | 40 |
| Comp. 5 | SA | 2 | 0.7 | Water | 43 |
| Comp. 6 | SA | 4 | 0.4 | CPD | 59 |
| Comp. 7 | SA | 4 | 0.7 | CPD | 53 |
| Comp. 8 | SA | 4 | 1.0 | CPD | 50 |

*SA = sulphuric acid;
PA = phosphoric acid
**abbreviations see table 3
***average of five measurements

From these results it is clear that the substrate prepared by anodizing in a mixture of sulphuric acid and phosphoric acid gives a much improved image quality on plate compared to the comparative substrates prepared by anodizing in sulphuric acid.

5. Printing.

5.A. With the Use of a Post-Gum Treatment

The plates were heated for five minutes at 90° C. in an oven to cure the image. Subsequently, all the plates were gummed with RC795 (finishing gum, trademark of AGFA).

Next the plates were mounted on a Sakurai Oliver 52 printing press using K+E 800 Skinnex Black (trademark of BASF) as ink and 4% Emerald Premium MXEH (trade mark of Anchor) as fountain solution. Both the clean-up and roll-up behaviour of the plates was very good and excellent print copies were obtained. The improved image quality observed on the aluminum substrates prepared by anodizing with a mixture of sulphuric acid and phosphoric acid was also observed on the prints.

5.B. Without the Use of a Post-Gum Treatment

The plates were heated for five minutes at 90° C. in an oven to cure the image.

Next the plates were mounted on a Sakurai Oliver 52 printing press using K+E 800 Skinnex (trademark of BASF) as ink and 4% Emerald Premium MXEH (trademark of Anchor) as fountain solution. Excellent print copies were obtained. Only the plates having a CPD post anodic treatment (ex. 6, 7, 8 and comp. ex. 6, 7 and 8) showed an acceptable clean-up and roll-up behaviour (<15 pages) and excellent print copies were obtained. All the other plates showed a very slow clean-up (>100 pages).

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for preparing a lithographic printing plate comprising the step of dispensing image-wise by means of ink jet printing droplets of a fluid on a hydrophilic metal substrate wherein said fluid comprises one or more reactive components selected from the group consisting of transition metal complexes and the hydrophilic metal is anodized in a medium comprising phosphoric acid or a mixture of a sulphuric and phosphoric acid.

2. A method according to claim 1 wherein said hydrophilic metal is grained and anodized aluminum.

3. A method according to claim 2 wherein the transition metal complexes comprise one or more chromium complexes of organic acids.

4. A method according to claim 3 wherein said one or more chromium complexes comprise one or more complexes of trivalent chromium and an organic carboxylic acid.

5. A method according to claim 4 wherein said organic carboxylic acid is selected from the group consisting of myristic acid and stearic acid.

6. A method according to claim 1 wherein said hydrophilic metal substrate has a surface roughness Ra between 0.2 and 1.5 micron.

7. A method according to claim 1 wherein said hydrophilic metal has an anodic weight between 1 and 8 g/m².

8. A method according to claim 1 wherein the transition metal complexes comprise one or more chromium complexes of organic acids.

9. A method according to claim 8 wherein said one or more chromium complexes comprise one or more complexes of trivalent chromium and an organic carboxylic acid.

10. A method according to claim 9 wherein said organic carboxylic acid is selected from the group consisting of myristic acid and stearic acid.

11. A method for preparing a lithographic printing plate comprising the steps:
1) dispensing image-wise by means of ink jet printing droplets of a fluid on a hydrophilic metal substrate wherein said fluid comprises one or more reactive components selected from the group consisting of transition metal complexes and the hydrophilic metal is anodized in a medium comprising a mixture of a sulphuric and phosphoric acid; and
2) exposing the printing plate to an energy source that activates said reactive component, thereby forming a durable and water-insoluble lithographic image on the hydrophilic metal.

12. A method according to claim 11 wherein said energy source in step 2) is heat.

13. A method according to claim 11 wherein said energy source in step 2) is selected from the group consisting of electron beam radiation, ultraviolet radiation, visible radiation and infrared radiation.

14. A method according to claim 13 wherein the transition metal complexes comprise one or more chromium complexes of organic acids.

15. A method according to claim 14 wherein said one or more chromium complexes comprise one or more complexes of trivalent chromium and an organic carboxylic acid.

16. A method according to claim 15 wherein said organic carboxylic acid is selected from the group consisting of myristic acid and stearic acid.

17. A method according to claim 1 wherein the printing plate is further treated with a finishing gum.
